(19) United States
(12) Patent Application Publication
(10) Pub. No.: US 2015/0006300 A1
(43) Pub. Date: Jan. 1, 2015

(54) CONTENT DISTRIBUTION THROUGH AN EXCHANGE

(71) Applicant: Google Inc., Mountain View, CA (US)

(72) Inventor: Patrick Hummel, Cupertino, CA (US)

(21) Appl. No.: 13/930,067

(22) Filed: Jun. 28, 2013

(51) Int. Cl. G06Q 30/02

(52) U.S. Cl. CPC G06Q 30/0275
USPC 705/14.71

(57) ABSTRACT

Methods, systems, and apparatus, including computer programs encoded on a computer storage medium, for distributing content through an exchange are disclosed. In one aspect, a method includes submission of a first bid to a content item selection process and receiving a request for one or more content items based on the first bid. A minimum price is determined based on a second bid that was submitted to the content item selection process by another entity. A set of content items having bids that meet the minimum price are identified, and a configuration of one or more content items that provides a threshold efficiency is identified. For each particular content item in the configuration of content items, a price that will be paid for distribution of the particular content item in the configuration is determined, and the price for at least one particular content item meets the minimum price.

### BACKGROUND

This specification relates to data processing.

The Internet facilitates the exchange of information and transactions between users across the globe. This exchange of information enables content item providers to provide sponsored content to a variety of users. A content item provider can control the distribution of their content items (e.g., promotions, advertisements, audio files, video files, or other content items) based on a set of parameters that specify under what conditions a content item is eligible to be distributed. When a presentation opportunity meeting the conditions is available, the content item is deemed eligible to be provided for presentation.

### SUMMARY

In general, one innovative aspect of the subject matter described in this specification can be embodied in methods that include the actions of submitting a first bid to a content item selection process; receiving a request for one or more content items to be presented with a resource based on the first bid; determining, based on a second bid that was submitted to the content item selection process by another entity, a minimum price that will be charged for distribution of the one or more content items; identifying a set of content items including one or more content items having bids that meet the minimum price; determining, from the set of content items, a configuration of one or more content items that provides a threshold efficiency, wherein an efficiency of the configuration is based on a value of the one or more content items in the configuration; and determining, for each particular content item in the configuration of content items, a price that will be paid for distribution of the particular content item in the configuration, wherein the price for at least one particular content item meets the minimum price. Other embodiments of this aspect include corresponding systems, apparatus, and computer programs, configured to perform the actions of the methods, encoded on computer storage devices.

These and other embodiments can each optionally include one or more of the following features. For example, methods can include the actions of receiving a bid request requesting a bid for a content item selection process, the bid request specifying one or more content item selection parameters; identifying, based on the one or more content item selection parameters, eligible content items that are eligible to be provided based on an outcome of the content item selection process; and determining a bid value for the bid based on a highest bid that is associated with one of the eligible content items.

Determining a configuration of content items that provides the threshold efficiency can include determining a configuration of content items that provides a higher efficiency than other configurations of content items. Determining a configuration of content items can include determining a maximum number of content items that are being requested for presentation with the resource; determining a total number of content items in the set of content items; and determining a number of content items from the set of content items that will provide a highest efficiency, wherein a maximum value for the number of content items is a lower of the maximum number and the total number.

Determining a number of content items that will provide a highest efficiency can include determining, for each configuration having a different number of content items between one and the maximum value, a position-adjusted value of each content item based on a position factor corresponding to a position of the content item in the configuration and a value associated with the content item; determining, for each configuration, an aggregate value based on the position adjusted value of each content item in the configuration; selecting the configuration having a highest aggregate value as a final configuration. Determining a number of content items that will provide a highest efficiency can include determining that a particular configuration having fewer than the maximum number of content items provides a highest efficiency.

Methods can include the action of determining the efficiency of the particular configuration based on a value of a particular content item and position factor for a presentation location to which the particular content item is assigned in the particular configuration.

Particular embodiments of the subject matter described in this specification can be implemented so as to realize none, one, or more of the following advantages. A content distribution system can ensure that the cost of distributing content is met by revenue from content providers when competing with other content distribution systems for the opportunity to fulfill a content request. The number of content items provided for presentation is limited to a number of content items that provide a highest aggregate position-adjusted value, which can result in fewer than a maximum number of possible content items being presented. Providing fewer than the maximum number of possible content items can help improve the user experience by reducing clutter in a resource.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content is distributed.

FIG. 2 is a block diagram of an example data flow for distributing content items through an exchange.

FIG. 3 is a flow chart of an example process for distributing content items through an exchange.

FIG. 4 is a block diagram of an example computer system.

Like reference numbers and designations in the various drawings indicate like elements.

### DETAILED DESCRIPTION

A content item distribution system (also referred to as a distribution system) can distribute content items through a content item distribution exchange (also referred to as an exchange) in which the distribution system competes with other content item distribution systems for the opportunity to distribute content items (e.g., advertisements, video files, audio files, or other content items) in response to a particular content item request. When competing for the opportunity to distribute content items, the distribution system can generally provide a bid specifying a maximum amount that the distribution system is willing to pay to distribute content items in response to the particular content item request. In some implementations, the distribution system can set the bid equal to, or based on, a maximum bid associated with an eligible content item that the distribution system is able to provide in response to the content item request.

When the distribution system is identified as a winning bidder by the exchange, the distribution system can select one or more content items to be provided in response to the content item request. The selected content items can be those content items that are associated with a bid that exceeds a minimum price that is determined by the distribution system. In some implementations, the minimum price can be set equal to, or based on, a second highest bid that was submitted to the exchange by another distribution system (e.g., a third party distribution system). In some implementations, the distribution system can identify, from a set of eligible content items having bids that meet the minimum price, a configuration (e.g., a particular number of) content items that provide a threshold (e.g., maximum or near maximum) value relative to other candidate configurations. The value provided by a particular configuration of content items is referred to herein as an efficiency of that particular configuration, and as described in detail below, can be determined based on a position-adjusted value of the content items in the particular configuration.

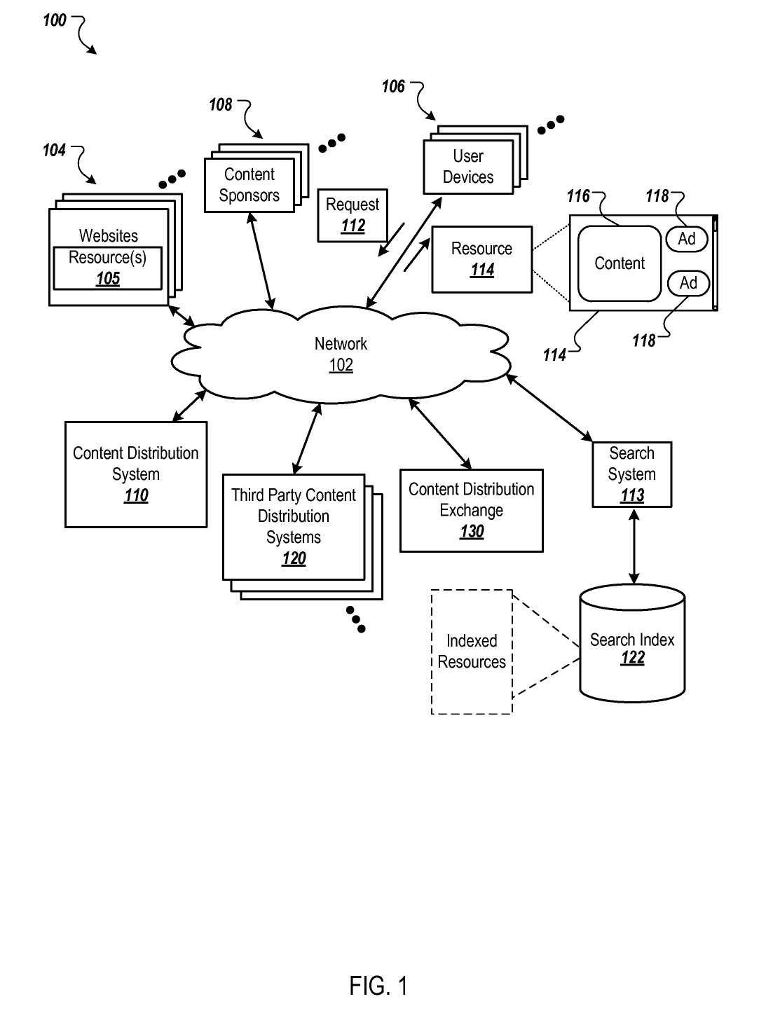

FIG. 1 is a block diagram of an example environment 100 in which content is distributed to user devices 106. The example environment 100 includes a network 102, such as a local area network (LAN), a wide area network (WAN), the Internet, or a combination thereof. The network 102 connects websites 104, user devices 106, content sponsors 108, a content distribution system 110, third party content distribution systems 120, and a content distribution exchange 130. The example environment 100 may include many different websites 104, user devices 106, content sponsors 108, and content distribution systems 120.

A website 104 is one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a publisher, which is an entity that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as scripts). Units of content that are presented in (or with) resources are referred to as content items, and an individual content item can be stored in a single file or set of files independent of the resource.

A user device 106 is an electronic device that is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can submit a resource request 112 that requests a resource 105 from a website 104. In turn, data representing the requested resource 114 can be provided to the user device 106 for presentation by the user device 106. The requested resource 114 can be, for example, a home page of a website 104, web page from a social network, or another resource 105. The data representing the requested resource 114 can include data that cause presentation of resource content 116 at the user device 106. The data representing the requested resource 114 can also include data specifying content item slots 118. A content item slot is a portion of the resource (e.g., a portion of a web page) or a portion of a user display (e.g., a presentation location of another window or in a slot of a web page) in which content items, such as advertisements, can be presented. Content items slots 118 can also be referred to as advertisement slots, but any type of content (e.g., content items other than advertisements) can be presented in these content item slots 118.

To facilitate searching of these resources, the environment 100 can include a search system 113 that identifies the resources by crawling and indexing the resources provided by the publishers on the websites 104. Data about the resources can be indexed based on the resource with which the data are associated. The indexed and, optionally, cached copies of the resources are stored in a search index 122. Data that are associated with a resource is data that represents content included in the resource and/or metadata for the resource.

User devices 106 can submit search queries to the search system 113 over the network 102. In response, the search system 113 accesses the search index 122 to identify resources that are relevant to the search query. The search system 113 identifies the resources in the form of search results and returns the search results to the user device in search results page. A search result is data generated by the search system 113 that identifies a resource that is responsive to a particular search query, and includes a link to the resource. An example search result can include a web page title, a snippet of text or a portion of an image extracted from the web page, and the URL of the web page. Like other resources, search results pages can include one or more content item slots in which content items, such as advertisements, can be presented.

When a resource 105 is requested by a user device 106, execution of code associated with a slot in the resource can initiate a request for a content item to populate the slot. When a resource 105 requests a content item, the presentation of the content item is referred to as an impression that is allocated to the content item, and the request is considered to be offering an impression opportunity.

In some implementations, impressions are allocated by a content distribution system 110. For example, some publishers enter into an agreement to have slots on their resources 105 populated by third party content items selected by the content distribution system 110. In some implementations, the publisher can include, in their resource 105, code that when executed by the user device 106, submits a request (i.e., a content item request) to the content distribution system 110.

The request can include characteristics of the slots that are defined for the requested resource 114. For example, a reference (e.g., URL) to the requested resource 114 for which the slot is defined, a size of the slot, and/or media types that are eligible for presentation in the slot can be provided to the content distribution system 110. Similarly, keywords associated with a requested resource (“resource keywords”) or entities that are referenced by the resource can also be provided to the content distribution system 110 to facilitate identification of content items that are relevant to the requested resource 114. The requests can also include other information, such as information that the user has provided, geographic information indicating a state or region from which the request was submitted, or other information that provides context for the environment in which the content item will be displayed (e.g., a type of device on which the content item will be displayed, such as a mobile device or tablet device).

The content items that are provided in response to a request (or another content item request) can be selected based at least in part on distribution parameters associated with the content items. Distribution parameters are a set of criteria upon which distribution of content items are conditioned. In some implementations, the distribution criteria for a particular content item can include distribution keywords that must be matched (e.g., by resource keywords or search queries) in order for the content item to be eligible for presentation. The distribution parameters can also specify a bid and/or budget for distributing the particular content item. In some implementations, bids can be used in an auction (or another content item selection process) to select which content item(s) will be presented and/or in which slot the content item(s) will be presented.

The environment 100 also includes a content distribution exchange 130. The content distribution exchange can be embodied in a data processing apparatus that can receive a request 112 and select a content distribution system to provide content items in response to the request. For example, instead of the content distribution system 110 receiving the request 112 and selecting content items based on the request, the content distribution exchange 130 can receive the request and then provide details about the request to the content distribution system 110 and third party content distribution systems 120. The content distribution exchange 130 can also provide a bid request requesting that the content distribution system 110 and one or more of the third party content distribution systems 120 each provide a bid to compete for the impression opportunity associated with the request.

In response to receiving a bid request, the content distribution system 110 and one or more of the third party content distribution systems 120 can each submit a bid specifying a maximum amount that will be paid by that content distribution system if selected to provide content items for content sponsors 108 that are associated with that content distribution system. As described in more detail below, the bid that is provided by the content distribution system 110 can be, for example, a maximum bid associated with a content item that is eligible to be provided in response to the request 112, which can be a quality adjusted bid. The third party content distribution systems 130 can similarly submit bids in response to the bid request.

In response to receiving the bid requests, the content distribution exchange 130 selects either the content distribution system 110 or one of the third party content distribution systems 120 to provide content items in response to the request. For example, the content distribution exchange can use the bids to perform an auction, and select an auction winner based on the outcome of the auction. Assume for purposes of example that the content distribution system 110 is the auction winner, and that one of the third party content distribution systems 120 was a runner-up in the auction. In this example, the price required to be paid by the content distribution system can be an amount up to the bid submitted by the content distribution system 110, and may be based on the bid submitted by the runner-up in the auction. For example, if the content distribution exchange utilizes a second price auction, the content distribution system 110 can be required to pay an amount equal to, or slightly greater than, the bid submitted by the runner-up.

When the content distribution system 110 is informed that it is the auction winner, the content distribution system 110 will select content items for distribution based, at least in part, on bids associated with the content items that are eligible to be provided in response to the request 112. For example, the content distribution system 110 may perform its own auction among the content item providers 108 that distribute content using the content distribution system 110. In turn, one or more auction winners will be selected, and each of those auction winners will pay a price up to their respective maximum bids for distribution of content items in response to the request. For example, assuming that the content distribution system 110 utilizes a second price auction, a winning content sponsor 108 will pay a price equal to, or slightly higher than, a bid submitted by the next highest bidder (i.e., the content sponsor that submitted the next highest bid to the content distribution system 110).

As described above, the price that the content distribution exchange charges the content distribution system 110 is based on the bids submitted by the third party content distribution systems 120, which can be independently operated by different entities. Meanwhile, the price that the content distribution system 110 charges the content sponsors 108 is based on the bids submitted to the content distribution system 110 by the content sponsors 108. Therefore, it is possible that the price paid to the content distribution exchange 110 by the content distribution system 110 is greater than the price paid to the content distribution system 110 by the content sponsors 108. Thus, the content distribution system 110 may lose money by using the content distribution exchange.

For purposes of illustration, assume that the content distribution system 110 submits a bid of $2.00 in response to a bid request received from the content distribution exchange 130, and that this bid equals the highest bid associated with a content item that the content distribution system is able to provide in response to the request 112. Further assume that the $2.00 bid is identified by the content distribution exchange as a winning bid, and that the next highest bid submitted by a third party content distribution system 120 is $1.50. In this example, the content distribution system may be required to pay $1.50 (or some incremental amount higher) to provide a content item in response to the request. When the second highest bid associated with a content item that can be provided by the content distribution system 110 is less than $1.50, the content distribution system 110 may receive less than $1.50 from the content sponsor 108 that is selected to provide a content item. Thus, the content distribution system 110 will lose money by providing a content item for the request 112.

In some implementations, the content distribution system 110 manages bids submitted to the content distribution exchange 130 and prices that content sponsors 108 are charged when the content distribution system 110 is selected as the winning bidder by the content distribution exchange. For example, as described in more detail below, the content distribution system 110 can select a maximum bid that will be submitted to the content distribution exchange 130 in response to a bid request, and determine, based on a runner-up bid submitted to the content distribution exchange, a price that one or more content sponsors 108 will be charged for distribution of content items through the content distribution exchange 130 to help ensure that the cost of distributing content items through the content distribution exchange 130 is at least equal to an amount paid by the content sponsors 108.

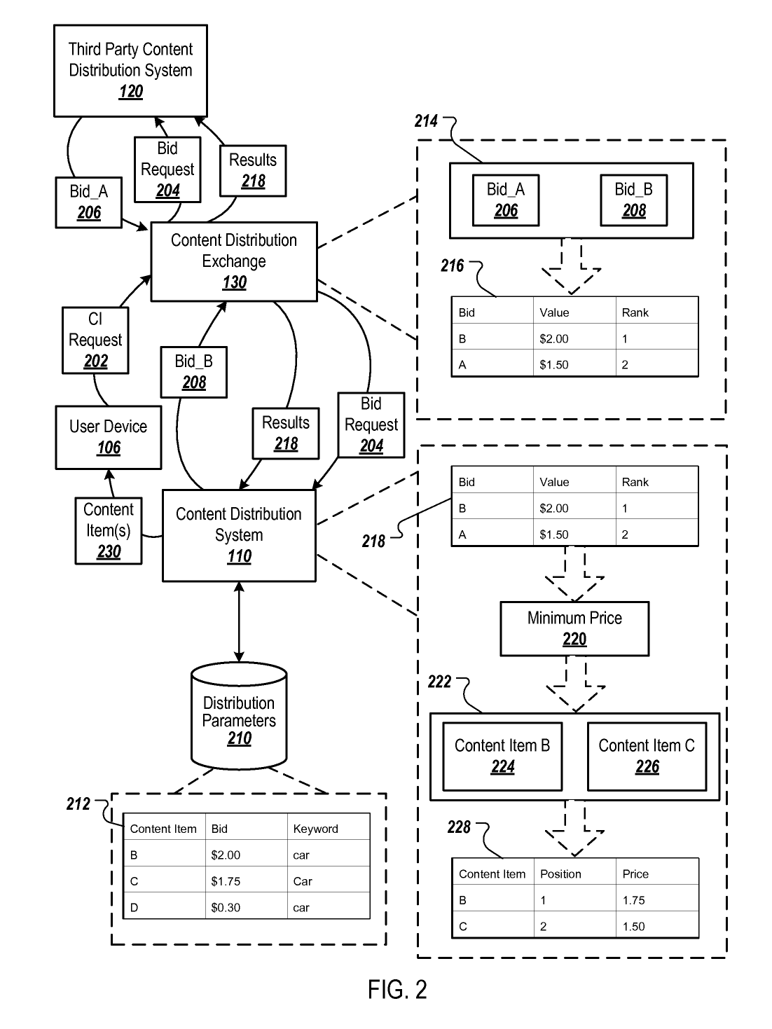

FIG. 2 is a block diagram of an example data flow 200 for distributing content items through an exchange. The data flow 200 begins with the content distribution exchange 130 receiving a content item request 202 (“CI Request”). The content item request 202 can be received, for example, from a user device 106 that is rendering a publisher's resource. For example, as described above, code included in the publisher's resource may cause the user device 106 to request a content item from the content distribution exchange. In some implementations, the content item request can be received from a content distribution system that utilizes the content distribution exchange 130 to obtain content items for presentation with a set of resources.

The content item request 202 can include one or more content item selection parameters that facilitate identification of a content item for presentation in response to the request. For example, the content item request can include characteristics of the content item slot in which a content item will be presented and information, such as a resource keyword, search query, or contextual data, with which a relevant content item can be selected.

In response to receiving the content item request 202, the content distribution exchange can issue a bid request 204 to each of the content distribution system 110 and to one or more third party content distribution system 120. The bid request 204 can include data requesting submission of bids specifying a maximum amount that will be paid by various content distribution systems. The bid request 204 can also include other information, such as a maximum number of content items that can be provided in response to the request and/or the content selection parameters that were received with, or are otherwise associated with, the content item request 202.

In response to the bid request 204, the third party content distribution system 120 can submit Bid_A 206 specifying a maximum amount that the third party content distribution system will pay for presentation of content items in response to the content item request 202. For example, assume that the third party content distribution system is willing to pay up to $1.50 for the opportunity to distribute one or more content items in response to the content item request 202. In this example, Bid_A 206 can be set to $1.50, and provided to the content distribution exchange 130.

The content distribution system 110 can similarly submit a bid in response to the bid request 204. As illustrated by FIG. 2, the content distribution system 110 submits Bid_B 208 in response to the bid request 204. In some implementations, the content distribution system can determine the value of Bid_B based on values of bids that are associated with eligible content items for the request.

An eligible content item is a content item that can be provided in response to a content item request. A content item can be deemed eligible to be provided in response to a content item request based on the content item being associated with distribution parameters that are (either partially or completely) matched by content item selection parameters that are included in the content item request 202. For example, if the content item request 202 includes data matching a distribution keyword for a content item, that content item may be deemed an eligible content item for the content item request.

The content distribution system 110 can access, or otherwise interact with, a distribution parameter data store 210 to identify eligible content items. For example, assume that the bid request 204 includes a content item selection parameter of “car.” In this example, the content distribution system 110 can identify, from the distribution parameter store 210, the content items that are distributed based on the keyword “car.” As illustrated by FIG. 2, the set of distribution parameters 212 identify content items B, C, and D as being associated with the distribution keyword “car,” and specifies a bid that is associated with each of the content items. Since the content items B, C, and D are each associated with the distribution keyword “car,” content items B, C, and D may each be considered an eligible content item to be provided in response to the content item request 202 that included the term “car” in the content item selection data.

In some implementations, the content distribution system 110 identifies a highest bid that is associated with the eligible content items. For example, the content distribution system 110 can identify, from the set of distribution parameters 212, the bid of $2.00 that is associated with content item B as the highest bid associated with the eligible content items identified in the set of distribution parameters 212. The content distribution system 110 can use this highest bid to determine the value of Bid_B 208 that will be submitted to the content distribution exchange 130.

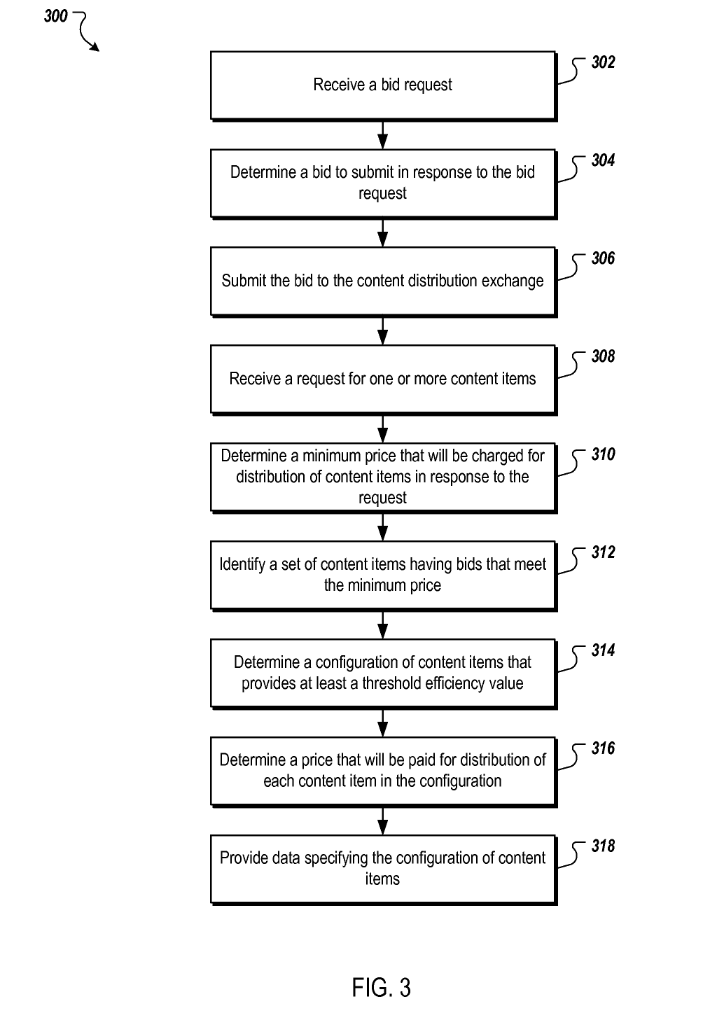

For example, as described in more detail below with reference to FIG. 3, the content distribution system 110 can determine the value of Bid_B 208 based on the maximum bid associated with the eligible content items and a position factor that represents a position-specific performance for the content item relative to a baseline performance of content items that are presented in the content item slot specified in the content item request 202. This position factor can be used to adjust the maximum bid of $2.00 to arrive at the value of Bid_B 208. Position factors are discussed in greater detail below. For purposes of the present discussion, it is assumed that the value of Bid_B 208 is set to $2.00, which is the value of the highest bid among the eligible content items.

The content distribution exchange collects the bids that are received from the various content distribution systems into a set of bids 214 for the content item request 202. As illustrated by FIG. 2, the set of bids includes Bid_A 206 and Bid_B 208, but could also include additional bids from other content distribution systems.

In some implementations, the content distribution exchange 130 ranks the bids based on their value. For example, as illustrated by table 216, Bid_B has been identified as the highest ranked bid with a value of $2.00, while Bid_A has been identified as the second highest ranked bid with a value of $1.50.

Based on the bid values and/or rankings, the content distribution exchange 130 can select Bid_B 208 as the winning bid and Bid_A as the runner-up bid, and distribute the results 218 of the selection process to the content distribution system 110 and the third party content distribution system 120. The results 218 can specify, for example, a winning bidder, a value of the winning bid, and/or a value of the runner-up bid.

In some implementations, the content distribution system determines a minimum price 220 to be paid by content sponsors for distribution of one or more of the eligible content items for the content item request 202. The minimum price 220 can be determined, for example, based on the results 218. For example, the content distribution system can set the minimum price 220 equal to the value of the runner-up bid, which in the present example is $1.50. In some implementations, the content distribution system 220 can adjust the value of the runner-up bid based on a position factor to arrive at the minimum price 220, as discussed with reference to FIG. 3.

In some implementations, the winning distribution system (in this example, content distribution system 110) thereafter identifies a set of the eligible content items 222 that are associated with a bid that meets the minimum price 220. For example, if the minimum price is set equal to $1.50, the content distribution system 110 can identify content item B 224 and content item C 226, which are respectively associated with bids of $2.00 and $1.75, as content items that are associated with bids that meet the minimum price. In this example, content item D, which was identified as an eligible content item, will not be considered for distribution in response to the content item request 202 since the $0.30 bid associated with content item D is less than $1.50, and therefore does not meet the minimum price 220.

The content distribution system 110 can select one or more content items from the set of eligible content items 222 for distribution in response to the content item request 202. In some implementations, the content items can be ranked based, at least in part, on their respective bids, and provided for presentation according to their respective rankings. In some implementations, a bid amount can be adjusted by a quality score to produce a ranking score (e.g., for the use in ranking individual content items). Table 228 provides a ranking of content item B 222 and content item C 224 based on the bids associated with these content items. In particular, content item B 222 has a highest ranking based on the bid of $2.00, while content item C 224 has a second highest ranking based on the bid of $1.75. If both content item B 222 and content item C 224 are provided in response to the content item request 202, content item B 222 can generally be presented in a highest position (e.g., highest performing position) of the resource (or content item slot), while content item C 224 will be presented in a second highest position (e.g., a position having a second highest performance).

In some implementations, fewer than all of the content items in the set of content items 222 will be provided in response to the content item request 202. For example, as described in more detail below with reference to FIG. 3, the content distribution system 110 can identify a proper subset of the set of content items 222 (i.e., fewer than all of the content items in the set of content items 222) to be provided in response to the content item request 202.

As described in further detail below, the number of content items selected to be provided in response to the content item request 202 can be selected based, at least in part on an efficiency measure for various configurations of content items. For example, a first efficiency measure can be determined for a first configuration in which only one of the content items (e.g., a first content item having a highest value) is presented in response to the content item request 202, and a second efficiency measure can be determined for a second configuration in which two content items (e.g., the first content item and a second content item having a second highest value) are provided in response to the content item request 202. In this example, assume that the first efficiency measure is higher than the second efficiency measure, such that only one content item is selected to be provided in response to the content item request 202.

As described in more detail below, the efficiency of a set of content items can generally represent a total value of the content items in the set, and the value of each content item can be based on a bid associated with the content item, a position factor for the position at which the content item will be presented, and/or a quality score of the content sponsor that provides the content item. The quality score can be based, at least in part, on historical performance of content items provided by the content sponsor relative to the performance of other content items provided by other content sponsors. As described in detail with reference to FIG. 3, because various factors, including the position factors of the various presentation positions, are used to determine the total value of a configuration, a configuration having a higher number of content items may actually have a lower efficiency than a configuration having a lower number of content items. Thus, the content distribution system 110 may elect to provide a proper subset of the set of content items 222 in response to the content item request 202.

The one or more content items 230 selected by the content distribution system 110 are provided to the user device 106 for presentation in response to the content item request 202. In some implementations, the one or more content items 230 are provided to the user device by the content distribution system 110. In some implementations, the content distribution system 110 provides data to the content distribution exchange 130 identifying the one or more content items 230. In turn, the content distribution exchange 130 can provide data to the user device instructing the user device to request the one or more content items 230 from a specified network location.

FIG. 3 is a flow chart of an example process 300 for distributing content items through an exchange. The process 300 can be performed by one or more data processing apparatus, such as the content distribution system 110 of FIG. 1. Operations of the process 300 can be implemented by execution of instructions stored on a non-transitory computer readable medium and that cause one or more data processing apparatus to perform operations of the process 300.

A bid request is received (302). In some implementations, the bid request is a request for a bid to be used in a content item selection process. For example, the content item selection process can be a content item auction that will be used to select a content item distribution system to provide content items for distribution through a content distribution exchange in which multiple different content distribution systems compete for the opportunity to provide content items in response to content item requests.

The bid request can include data specifying one or more content item selection parameters with which eligible content items can be identified. For example, as described above, the bid request can specify a keyword or topic corresponding to a resource with which content items will be presented and/or other information that can be used for content item selection (e.g., a size of a content item slot in which content items will be presented and/or a total number of content items that can be presented in the content item slot).

A bid that will be submitted in response to the bid request is determined (304). In some implementations the bid that will be submitted can be determined based, at least in part, on a highest bid that is associated with one of the eligible content items. The highest bid can be identified, for example, based on bids for content items having distribution parameters that match content item selection parameters included in the bid request. For example, assume that the bid request includes the content item selection keyword “car,” and there are a set of eligible content items that are eligible for distribution based on the distribution keyword “car” being matched by content item selection parameters that include the keyword “car.” In this example, the bids associated with a set of eligible content items can be used to identify the bid that will be submitted in response to the bid request. For example, the highest bid that is associated with the set of eligible content items can be identified as the bid that will be submitted in response to the bid request.

Note that the matching keyword example is provided above for purposes of illustration only. Any combination of distribution parameters can be required to be matched by content item selection parameters for a content item to be eligible for distribution. Also note that the term “bid,” as used throughout this document inclusively refers to either a maximum amount that a content sponsor is willing to pay for distribution of a content item or an adjusted value based on the maximum amount specified by the content sponsor. For example, as used throughout this document, the maximum amount specified by a content sponsor can be adjusted based on a quality score corresponding to the content sponsor and/or other data.

In a particular example, the bid for a content item can be a product of (or another mathematical function of) the maximum amount specified by the content sponsor and a quality score. The quality score can be based, for example, on a performance of content items provided by the content sponsor relative to the performance of content items provided by other content sponsors. For example, assume that an average click through rate for content items provided by a particular content sponsor is ten percent higher than the average click through rate of all content sponsors. In this example, the quality score for the particular content sponsor can be set to 1.1 reflecting the increased performance of content items provided by that content sponsor relative to the performance of content items in general. The quality score can be determined on a per-sponsor, per-resource, per-publisher, and/or per-content item basis, such that a particular content sponsor can be associated with multiple different quality scores. In some implementations, quality scores for content item providers are normalized so that all quality scores are within a specified range. For example, quality score can be normalized so that all quality scores are in a range of 0.0-1.0, where a quality score of 1.0 is a highest possible quality score.

In some implementations, the value of the bid that will be submitted in response to the bid request can be based on a position factor. For example, the value of the bid can be adjusted using a position factor for a configuration in which only a single content item is presented in the content item slot. In a particular example, the value of the bid can be determined based on relationship (1).

Bid=b_{—}1/(PF_{—}1,1) (1)

where,

Bid is the bid that will be submitted in response to the bid request;

b_{—}1 is the maximum bid among the set of eligible content items; and

PF_{—}1,1 is the position factor corresponding to a configuration in which only a single content item is presented.

As noted above with reference to FIG. 2, a position factor can represent a position-specific performance for a presentation position. For example, the position factor for a particular presentation position in a content item slot can represent the performance of content items presented in that particular presentation position relative to a baseline performance of content items. The baseline performance can be, for example, an average performance of content items presented in a reference presentation position (e.g., a highest performing or lowest performing presentation position). For example, assume that two presentation positions are available in a particular content item slot, and that the average click through rate for content items presented in a first of the presentation positions is 0.20, and that the average click through rate for content items presented in the second presentation position is 0.10. In this example, the baseline performance can be set to 0.20, and the position factor for the second presentation position can be 0.5 (e.g., 0.10/0.20). In some implementations, the baseline performance can be based on an average performance of all content items presented in the content item slot (e.g., irrespective of presentation position).

Using the baseline performance, the position factor for a particular presentation position can be determined according to relationship (2).

PF(i,j)=CI_Perf(i,j)/CI_Perf(bl) (2)

where,

PF(i,j) is the performance factor for presentation position i when j content items are presented in the content item slot;

CI_Perf(i,j) is the performance of content items presented in position i when j content items are presented in the content item slot; and

CI_Perf(bl) is the baseline performance.

A single presentation position may be associated with multiple different performance factors. For example, performance factors can be determined on a per-content sponsor basis, and used to adjust bids associated for each respective content sponsor. Also, a particular presentation position may have a first performance factor when two content items are presented in the content item slot, and have a second different performance factor when three content items are presented in the content item slot.

For example, assume that the performance of content items presented in a second presentation position (e.g., a second highest performing presentation position) of a content item slot has a value of 0.4 (e.g., a click through rate of 0.4) when only two content items are presented in the content item slot, and has a value of 0.1 (e.g., a click through rate of 0.1) when three content items are presented in the content item slot. In this example, the presenting three content items in the content item slot, instead of presenting two content items, reduces the performance of the second content item slot. Thus, the performance factor for the second presentation position in a two content item configuration will be higher than the performance factor for the second presentation position in a three content item configuration.

Similarly, when only a single content item is presented in the content item slot, the performance factor for the single presentation position can generally be higher than the performance factor for a highest presentation position when two or more content items are presented in the content item slot, since presentation of the additional content items will reduce the prominence of the highest presentation position.

The bid is submitted to the content distribution exchange (306). For example, a content distribution system that distributed content of a set of content sponsors can submit the bid to a content distribution exchange that provides presentation opportunities to multiple different content distribution systems. The submitted bid and any other bids submitted by other content distribution systems can be used in a content item selection process to determine which content distribution system will be granted the opportunity to provide content items for presentation in response to a particular presentation opportunity. For example, the content distribution exchange can perform an auction using the bids submitted by the content distribution systems, and identify the auction winner as the content distribution system that will provide one or more content items in response to the content item request.

A request for one or more content items is received (308). In some implementations, the request is received by the content distribution system in response to the content distribution exchange identifying the submitted bid as a winning bid of the content item selection process. For example, assume that the submitted bid is identified as a highest bid among those bids submitted by various content distribution systems. In this example, the submitted bid can be identified as a winning bid, and the content distribution system that submitted the bid can be identified as a winning bidder. In response to identifying the submitted bid as a winning bid, results of the selection process can be provided to the content distribution system that submitted the winning bid and/or other content distribution systems that were not identified as winning bidders.

In some implementations, the request also specifies a maximum number of content items that are able to be presented in the content item slot for which content items are being requested. For example, assume that between one and three content items can be presented in a particular content items slot for which content items are being requested. In this example, the request can specify that a maximum of three content items can be provided in response to the request.

A minimum price that will be charged for distribution of content items in response to the request is determined (310). In some implementations, the minimum price is determined based on a bid that was submitted to the content distribution exchange by another entity. For example, the minimum price can be set equal to, or determined based on, the bid submitted by a runner-up in the content item selection process. In other words, the minimum price can be set equal to, or determined, based on a second highest bid that was submitted to the content item exchange in response to the bid request.

In some implementations, the minimum price can be determined based on the runner-up bid and a position factor. For example, the minimum price can be determined using relationship (3).

Min_Price=b_{—}2/(PF_{—}1,1) (3)

where,

Min_Price is the minimum price that will be charged for distribution of content items in response to the content item request;

b_{—}2 is the runner-up bid in the content distribution exchange selection process; and

PF_{—}1,1 is the position factor corresponding to a configuration in which only a single content item is presented.

A set of content items having bids that meet the minimum price is identified (312).

As described above with reference to FIG. 2, the set of content items can include each eligible content item having a bid that equals or exceeds the minimum price. In some implementations, the set of content items includes a proper subset of the eligible content items having a bid that equals or exceeds the minimum price. For example, the set of content items can be limited to include only the highest ranking “N” content items, where “N” is an integer corresponding to (e.g., equal to), a maximum number of content items specified in the request for one or more content items.

In some implementations, the ranking of the eligible content items is based on the bids associated with the eligible content items. For example, the eligible content items can be ranked in descending order based on their respective bids, where a highest ranked eligible content item will have a highest bid; a second highest ranked eligible content item will have a second highest bid; and so on. In some implementations, the ranking of the eligible content items is based on values of the eligible content items, where the value of each eligible content item is based, at least in part, on a function of the bid associated with the eligible content item and a quality score for a content sponsor that provides the content item.

For example, assume that three content items are identified as eligible content items, and that the three eligible content items have the attributes listed in Table 1.

TABLE 1

| | | Content Sponsor | |
|---|---|---|---|
| | | Quality Score | Content Item |
| Content Item | Bid | (“QS”) | Value = Bid*QS |
| 1 | 2.00 | 0.8 | 1.60 |
| 2 | 1.75 | 0.6 | 1.05 |
| 3 | 1.25 | 0.9 | 1.125 |

In this example, if the content items are ranked based solely on their respective bids, the content item 1 will be a highest ranked content items, content item 2 will be a second highest ranked content item, and content item 3 will be the third highest ranked content item. If the content items are ranked based on a value derived from a product of the bid and the quality score, the ranking changes in that content item 3 is the second highest ranked content item, while content item 2 becomes the second highest ranked content item.

A configuration of one or more content items that provides at least a threshold efficiency value is determined (314). In some implementations, the efficiency of each configuration is based on the values of the one or more content items that are included in the configuration. For example, for each candidate configuration of content items, the efficiency of the candidate configuration can be a sum of the values of the content items that are included in the configuration. The candidate configurations can include configurations that include one to “N” content items, where “N” is an integer corresponding to a maximum number of content items that can be presented in the content item slot, and each different number of content items can constitute a different configuration.

In some implementations, the threshold efficiency is specified to be a maximum efficiency that is provided by any candidate configurations. For example, assume that three different candidate configurations of content items are available (e.g., a one content item configuration, a two content item configuration, and a three content item configuration). In this example, the threshold efficiency can be provided by the configuration that provides the highest efficiency. Note that the threshold efficiency can also be specified as an absolute efficiency value or a relative efficiency value (e.g., relative to an efficiency provided by one or more other configurations).

In some implementations, the configuration that provides the threshold efficiency is identified from all candidate configurations that can be created using up to the maximum number of content items that can be provided in response to the content item request. For example, the maximum number of content items that can be provided can be identified from the content item request, and the total number of eligible content items that are included in the set of eligible content items can be determined. In this example, the maximum number of content items that can be provided in response to the content item request can be determined to be a lower of the maximum number specified in the content item request and the total number of eligible content items.

The candidate configurations can be determined based, at least in part, on the maximum number of content item requests that can be provided in response to the content item request. For example, assume that up to three content items can be presented in a content item slot, and that only two eligible content items are available to be provided in response to the content item request. Further assume that each configuration differs in the number of content items that are presented. In this example, two content items can be provided in response to the request, and there can be two different candidate configurations (e.g., the highest ranking content item can be presented alone in one candidate configuration and both eligible content items can be presented in another candidate configuration).

Once the candidate configurations have been identified, a position adjusted value can be determined for each of the content items in the candidate configuration. The position adjusted value can be based, for example, on a product of (or another mathematical combination of) the value of the content item and a position factor corresponding to the presentation of the content item in the candidate configuration. The position adjusted values can be used to determine an aggregate value for each of the candidate configurations, and the candidate configuration having the highest aggregate value can be selected as the final configuration of content items that will be provided in response to the content item request.

For purposes of example, assume the content item request specifies that up to three content items can be presented in the content item slot for which content items are being requested. In this example, the candidate configurations can include a first configuration in which only a single content item is presented, a second configuration in which two content items are presented, and a third configuration in which three content items are presented in the content item slot. Further assume that the set of content items having bid meeting the minimum price are the content items identified in Table 1 above. In this example, the efficiency of each candidate configuration can be determined as provided in Table 2.

TABLE 2

| Number of Presen- tation Posi- tions in Configu- ration (j) | Content Item(s) (i) Included in Configuration | Position Factors | Config. Efficiency $Eff = {\sum }_{i = 1}^{j} {v}_{i} {PF}_{i , j}$ |
|---|---|---|---|
| 1 | Position 1 = | Position 1 = 1.5 | 1.6*1.5 = 2.4 |
| | Content Item 1 | | |
| 2 | Position 1 = | Position 1 = 1.1 | (1.6*1.1) + |
| | Content Item 1 | | (1.125*0.7) = |
| | Position 2 = | Position 2 = 0.7 | 2.5475 |
| | Content Item 3 | | |
| 3 | Position 1 = | Position 1 = 0.6 | (1.6*0.6) + |
| | Content Item 1 | | (1.125*0.2) + |
| | Position 2 = | Position 2 = 0.2 | (1.05*0.2) = |
| | Content Item 3 | | 1.395 |
| | Position 3 = | Position 3 = 0.2 | |
| | Content Item 2 | | |

As presented in Table As presented in Table 2, the configuration in which content item 1 is presented in the first presentation position and content item 3 is presented in the second presentation position is associated with a highest efficiency. Therefore, in this example, content item 1 and content item 3 can be selected for presentation in response to the content item request.

A price that will be paid for distribution of each particular content item in the configuration that provides the threshold efficiency value is determined (316). In some implementations, the price that will be paid for distribution of a particular content item is based on the minimum price. For example, each content sponsor that provides one of the content items in the configuration that provides the threshold efficiency can be charged a price at least equal to the minimum price determined above.

In some implementations, the price paid for distribution of each content item in the configuration can be determined using the minimum price as a bid in a Vickrey-Clarke-Groves (“VCG”) pricing technique. For example, in addition to using the bids corresponding to each of the content items in the configuration, the minimum price determined above can also be input, as a bid, to the VCG pricing technique. Therefore, the VCG pricing technique will compute the price paid by each content sponsor as if there was an additional content sponsor (e.g., a first losing content sponsor) that submitted a bid equal to the minimum price. Accordingly, each of the content sponsors will pay a price at least equal to the minimum price.

Data specifying the configuration of content items is provided (318). In some implementations, the data specify the content items that were selected to be presented in the content item slot for which the content items were requested. The data can also specify a total number of content items that are to be presented in the content item slot, and/or a position in which each of the content items are to be presented. The data can be provided, for example, to the content distribution exchange or the user device corresponding to the content item request.

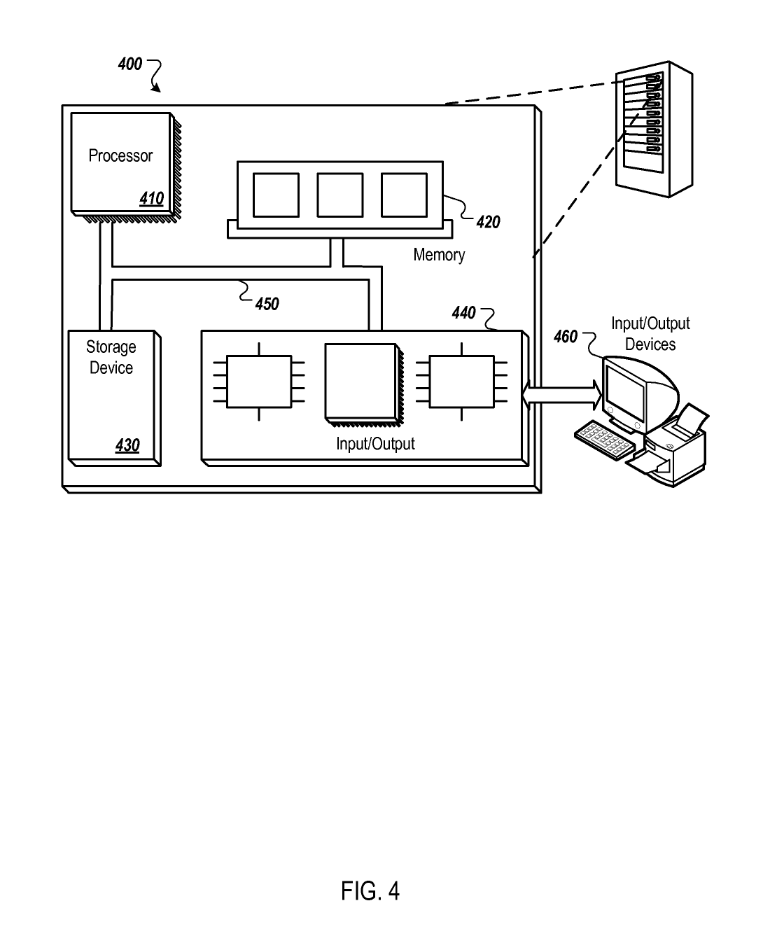

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
submitting a first bid to a content item selection process;
receiving a request for one or more content items to be presented with a resource based on the first bid;
determining, based on a second bid that was submitted to the content item selection process by another entity, a minimum price that will be charged for distribution of the one or more content items;
identifying a set of content items including one or more content items having bids that meet the minimum price;
determining, from the set of content items, a configuration of one or more content items that provides a threshold efficiency, wherein an efficiency of the configuration is based on a value of the one or more content items in the configuration; and
determining, for each particular content item in the configuration of content items, a price that will be paid for distribution of the particular content item in the configuration, wherein the price for at least one particular content item meets the minimum price.

2. The method of claim 1, comprising:
receiving a bid request requesting a bid for a content item selection process, the bid request specifying one or more content item selection parameters;
identifying, based on the one or more content item selection parameters, eligible content items that are eligible to be provided based on an outcome of the content item selection process; and
determining a bid value for the bid based on a highest bid that is associated with one of the eligible content items.

3. The method of claim 1, wherein determining a configuration of content items that provides the threshold efficiency comprises determining a configuration of content items that provides a higher efficiency than other configurations of content items.

4. The method of claim 1, wherein determining a configuration of content items comprises:
determining a maximum number of content items that are being requested for presentation with the resource;
determining a total number of content items in the set of content items; and
determining a number of content items from the set of content items that will provide a highest efficiency, wherein a maximum value for the number of content items is a lower of the maximum number and the total number.

5. The method of claim 4, wherein determining a number of content items that will provide a highest efficiency comprises:
determining, for each configuration having a different number of content items between one and the maximum value, a position-adjusted value of each content item based on a position factor corresponding to a position of the content item in the configuration and a value associated with the content item;
determining, for each configuration, an aggregate value based on the position adjusted value of each content item in the configuration;
selecting the configuration having a highest aggregate value as a final configuration.

6. The method of claim 4, wherein determining a number of content items that will provide a highest efficiency comprises determining that a particular configuration having fewer than the maximum number of content items provides a highest efficiency.

7. The method of claim 6, comprising determining the efficiency of the particular configuration based on a value of a particular content item and position factor for a presentation location to which the particular content item is assigned in the particular configuration.

8. A non-transitory computer storage medium encoded with a computer program, the program comprising instructions that when executed by one or more data processing apparatus cause the one or more data processing apparatus to perform operations comprising:
submitting a first bid to a content item selection process;
receiving a request for one or more content items to be presented with a resource based on the first bid;
determining, based on a second bid that was submitted to the content item selection process by another entity, a minimum price that will be charged for distribution of the one or more content items;
identifying a set of content items including one or more content items having bids that meet the minimum price;
determining, from the set of content items, a configuration of one or more content items that provides a threshold efficiency, wherein an efficiency of the configuration is based on a value of the one or more content items in the configuration; and
determining, for each particular content item in the configuration of content items, a price that will be paid for distribution of the particular content item in the configuration, wherein the price for at least one particular content item meets the minimum price.

9. The computer storage medium of claim 8, wherein the instructions cause the one or more data processing apparatus to perform operations comprising:
receiving a bid request requesting a bid for a content item selection process, the bid request specifying one or more content item selection parameters;
identifying, based on the one or more content item selection parameters, eligible content items that are eligible to be provided based on an outcome of the content item selection process; and
determining a bid value for the bid based on a highest bid that is associated with one of the eligible content items.

10. The computer storage medium of claim 8, wherein determining a configuration of content items that provides the threshold efficiency comprises determining a configuration of content items that provides a higher efficiency than other configurations of content items.

11. The computer storage medium of claim 8, wherein determining a configuration of content items comprises:
determining a maximum number of content items that are being requested for presentation with the resource;
determining a total number of content items in the set of content items; and
determining a number of content items from the set of content items that will provide a highest efficiency, wherein a maximum value for the number of content items is a lower of the maximum number and the total number.

12. The computer storage medium of claim 11, wherein determining a number of content items that will provide a highest efficiency comprises:
determining, for each configuration having a different number of content items between one and the maximum value, a position-adjusted value of each content item based on a position factor corresponding to a position of the content item in the configuration and a value associated with the content item;
determining, for each configuration, an aggregate value based on the position adjusted value of each content item in the configuration;
selecting the configuration having a highest aggregate value as a final configuration.

13. The computer storage medium of claim 11, wherein determining a number of content items that will provide a highest efficiency comprises determining that a particular configuration having fewer than the maximum number of content items provides a highest efficiency.

14. A system, comprising:
a data store storing distribution parameters for one or more content items, the distribution parameters including bids corresponding to the one or more content items;
one or more data processing apparatus that execute instructions that cause the one or more data processing apparatus to perform operations comprising:
submitting a first bid to a content item selection process;
receiving a request for one or more content items to be presented with a resource based on the first bid;
determining, based on a second bid that was submitted to the content item selection process by another entity, a minimum price that will be charged for distribution of the one or more content items;
identifying, based on the distribution parameters, a set of content items including one or more content items having bids that meet the minimum price;
determining, from the set of content items, a configuration of one or more content items that provides a threshold efficiency, wherein an efficiency of the configuration is based on a value of the one or more content items in the configuration; and
determining, for each particular content item in the configuration of content items, a price that will be paid for distribution of the particular content item in the configuration, wherein the price for at least one particular content item meets the minimum price.

15. The system of claim 14, wherein the instructions cause the one or more data processing apparatus to perform operations comprising:
receiving a bid request requesting a bid for a content item selection process, the bid request specifying one or more content item selection parameters;
identifying, based on the one or more content item selection parameters, eligible content items that are eligible to be provided based on an outcome of the content item selection process; and
determining a bid value for the bid based on a highest bid that is associated with one of the eligible content items.

16. The system of claim 14, wherein determining a configuration of content items that provides the threshold efficiency comprises determining a configuration of content items that provides a higher efficiency than other configurations of content items.

17. The system of claim 14, wherein determining a configuration of content items comprises:
determining a maximum number of content items that are being requested for presentation with the resource;
determining a total number of content items in the set of content items; and
determining a number of content items from the set of content items that will provide a highest efficiency, wherein a maximum value for the number of content items is a lower of the maximum number and the total number.

18. The system of claim 17, wherein determining a number of content items that will provide a highest efficiency comprises:
determining, for each configuration having a different number of content items between one and the maximum value, a position-adjusted value of each content item based on a position factor corresponding to a position of the content item in the configuration and a value associated with the content item;
determining, for each configuration, an aggregate value based on the position adjusted value of each content item in the configuration;
selecting the configuration having a highest aggregate value as a final configuration.

19. The system of claim 17, wherein determining a number of content items that will provide a highest efficiency comprises determining that a particular configuration having fewer than the maximum number of content items provides a highest efficiency.

20. The system of claim 19, wherein the instructions cause the one or more data processing apparatus to perform operations comprising determining the efficiency of the particular configuration based on a value of a particular content item and position factor for a presentation location to which the particular content item is assigned in the particular configuration.
